(19) United States
(12) Patent Application Publication
(10) Pub. No.: US 2025/0314063 A1
(43) Pub. Date: Oct. 9, 2025

(54) BUILDING PANEL

(71) Applicant: ARMSTRONG WORLD INDUSTRIES, INC., Lancaster, PA (US)

(72) Inventors: Charles G. KRICK, Lititz, PA (US); Gourish SIRDESHPANDE, Lancaster, PA (US); Jacob D. PETERSON, Aliquippa, PA (US); Kimberly S. DIFFENBAUGH, Lancaster, PA (US); Edward E. WISE, Lancaster, PA (US)

(21) Appl. No.: 18/866,729

(22) PCT Filed: May 15, 2023
(86) PCT No.: PCT/US2023/022270

§ 371 Date: Nov. 18, 2024

Related U.S. Application Data
(60) Provisional application No. 63/342,229, filed on May 16, 2022.

(51) Int. Cl. E04B 1/90; C04B 38/00; C04B 111/52; E04B 9/00

(52) U.S. Cl. CPC E04B 1/90; C04B 38/0074; E04B 9/001; C04B 2111/52; C04B 2201/20

(57) ABSTRACT

Described herein are acoustic building panels having a body including inorganic fiber, biochar, and a flame retardant and methods of manufacturing the acoustic building panels. In some embodiments, the biochar and the flame retardant may be present in a weight ratio ranging from about 1:1 to about 6:1. In some embodiments, the flame retardant may include an active filler flame retardant.

### CROSS-REFERENCE TO RELATED APPLICATIONS

This application is a U.S. Non-Provisional Application claiming priority to PCT International Application No. PCT/US2023/022270, filed May 15, 2023, claiming priority to U.S. Provisional Patent Application No. 63/342,229 filed on May 16, 2022, the disclosures of which are incorporated herein by reference in their entirety.

### BACKGROUND

Carbon dioxide (CO₂) emissions have been identified as a major contributor to global warming and ocean acidification. Building products and the materials used to form such building products are a contributor to CO₂ emissions. Therefore, a need exists for building products that help reduce or eliminate CO₂ emissions. Furthermore, such new building products should be developed without sacrifice of fire resistance, mechanical, and/or acoustic performance characteristics necessary for such building products to function as desired.

### BRIEF SUMMARY

According to some embodiments, an acoustic building panel may include a body. The body may include inorganic fiber in an amount ranging from about 5 wt. % to about 75 wt. % based on the total weight of the body, biochar in an amount ranging from about 5 wt. % to about 50 wt. % or from about 10 wt. % to about 40 wt. %; and a flame retardant in an amount ranging from about 1 wt. % to about 30 wt. % based on the total weight of the body. The biochar and the flame retardant may be present in a weight ratio ranging from about 1:1 to about 6:1.

According to some embodiments, an acoustic building panel may include a body. The body may include inorganic fiber in an amount ranging from about 5 wt. % to about 75 wt. % based on the total weight of the body; biochar in an amount ranging from about 5 wt. % to about 50 wt. % based on the total weight of the body; and a flame retardant in an amount ranging from about 1 wt. % to about 30 wt. % based on the total weight of the body. The flame retardant may include colemanite.

According to some embodiments, a ceiling system may include a support structure and at least one of the aforementioned acoustic building panel mounted to the support structure.

According to some embodiments, a method of manufacturing an acoustic building panel may include mixing inorganic fiber, binder, biochar, a flame retardant, and a liquid carrier to form a blend; and shaping and drying the blend into a body having a first major surface opposite a second major surface and side surfaces extending between the first and second major surface. The body may be substantially free of the liquid carrier. The biochar and the flame retardant may be present in a weight ratio ranging from about 1:1 to about 6:1.

According to some embodiments, a method of manufacturing an acoustic building panel may include mixing inorganic fiber, binder, biochar, a flame retardant, and a liquid carrier to form a blend; and shaping and drying the blend into a body having a first major surface opposite a second major surface and side surfaces extending between the first and second major surface. The body may be substantially free of the liquid carrier. The flame retardant may include colemanite.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a building panel according to some embodiments of the present invention;

FIG. 2 is a cross-sectional view of the building panel according to some embodiments of the present invention, the cross-sectional view being along the II line set forth in FIG. 1; and

FIG. 3 is a ceiling system comprising the building panel according to some embodiments of the present invention.

FIGS. 4A and 4B show heat release rate and panel mass of a control panel.

FIGS. 5A and 5B show heat release rate and panel mass of a first exemplary building panel according to some embodiments of the present invention.

FIGS. 6A and 6B show heat release rate and panel mass of a second exemplary building panel according to some embodiments of the present invention.

FIGS. 7A and 7B show heat release rate and panel mass of a third exemplary building panel according to some embodiments of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” means less than about 0.1 wt. % based on the total of the referenced value.

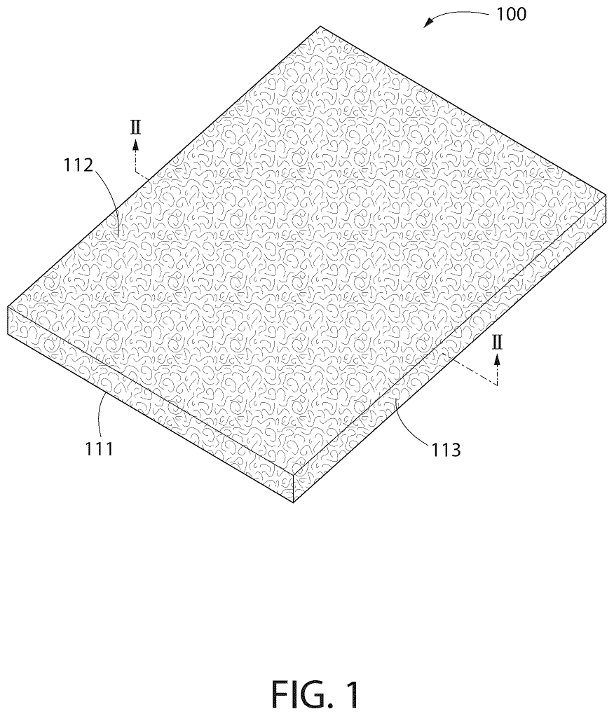

Referring to FIG. 1, the building panel 100 according to some embodiments of the present invention may comprise a first major surface 111 opposite a second major surface 112. The ceiling panel 100 may further comprise a side surface 113 that extends between the first major surface 111 and the second major surface 112, thereby defining a perimeter of the ceiling panel 100.

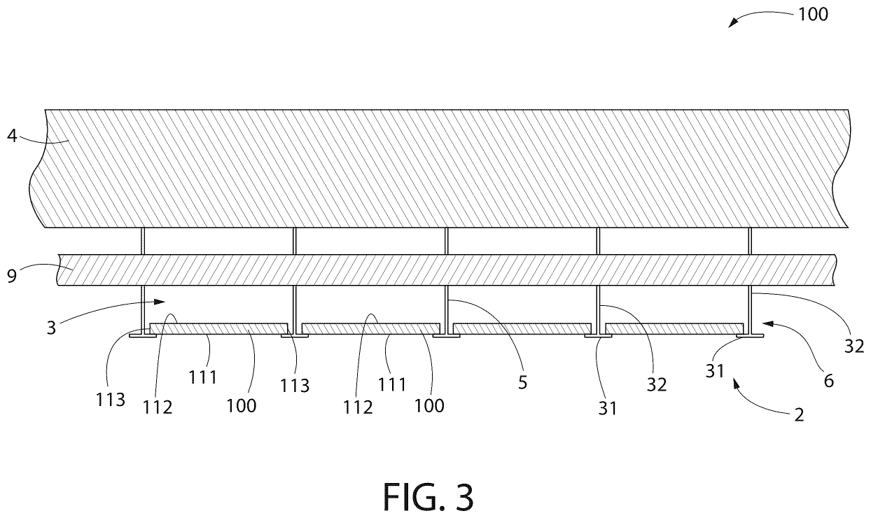

Referring to FIG. 3, in some embodiments, the present invention may further include a building system 1—also referred to as a ceiling system 1 comprising one or more of the building panels 100 installed in an interior space, whereby the interior space comprises a plenary space 3 and an active room environment 2. The plenary space 3 provides space for mechanical lines 9 within a building (e.g., HVAC, plumbing, etc.). The active space 2 provides room for the building occupants during normal intended use of the building (e.g., in an office building, the active space would be occupied by offices containing computers, lamps, etc.).

The ceiling system 1 may include a ceiling support grid 6 and at least one building panel 100 supported by the ceiling support grid 6, the building panel 100 having the first major surface 111 opposite the second major surface 112, and the second major surface 112 facing upward and the first major surface 111 facing downward.

In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid 6. The plenary space 3 exists above the ceiling support grid and the active room environment 2 exists below the ceiling support grid 6. In the installed state, the first major surface 111 of the building panel 100 faces the active room environment 2 and the second major surface 112 of the building panel 100 faces the plenary space 3.

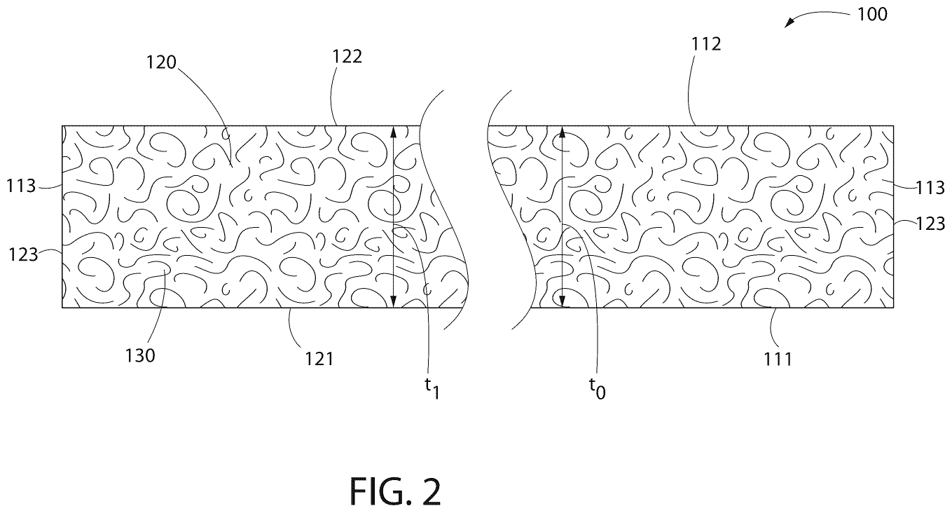

Referring now to FIGS. 1 and 2, in some embodiments, the building panel 100 may have a panel thickness to as measured from the first major surface 111 to the second major surface 112. The panel thickness to may range from about 12 mm to about 40 mm—including all values and sub-ranges there-between. The building panel 100 may have a length ranging from about 30 cm to about 310 cm—including all values and sub-ranges there-between. The building panel 100 may have a width ranging from about 10 cm to about 125 cm—including all values and sub-ranges there-between.

In some embodiments, the building panel 100 may comprise a body 120 having an upper surface 122 opposite a lower surface 121 and a body side surface 123 that extends between the upper surface 122 and the lower surface 121, thereby defining a perimeter of the body 120. The body 120 may have a body thickness t₁ that extends from the upper surface 122 to the lower surface 121. The body thickness t₁ may range from about 12 mm to about 40 mm—including all values and sub-ranges there-between.

In some embodiments, the first major surface 111 of the building panel 100 may comprise the lower surface 121 of the body 120. The second major surface 112 of the building panel 100 may comprise the upper surface 122 of the body 120. When the first major surface 111 of the building panel 100 comprises the lower surface 121 of the body 120 and the second major surface 112 of the building panel 100 comprises the upper surface 122 of the body 120, the panel thickness t₀ is substantially equal to the body thickness t₁.

As discussed in greater detail herein, in some embodiments, the body 120 may be porous, thereby allowing airflow through the body 120 between the upper surface 122 and the lower surface 121.

In some embodiments, the body 120 may include fibers 130. The fibers 130 may include a fibrous component. In some embodiments, the fibrous component may include organic fiber, inorganic fiber, and combinations thereof. In some embodiments, the body 120 may further include biochar. In some embodiments, the body 120 may further include a flame retardant. In some embodiments, the body 120 may further include a filler and/or additive. In some embodiments, the body 120 may further include a binder.

The fibrous component of the fibers 130 may be organic fibers, inorganic fibers, or a blend thereof. Non-limiting examples of inorganic fibers include mineral wool (also referred to as slag wool), rock wool, stone wool, glass fibers, and polymer fibers. Non-limiting examples of polymer fibers include polyester fiber, polyethylene fiber, aramid fiber (e.g., aromatic polyamide fiber), and polypropylene fiber. Non-limiting examples of organic fiber include macroscopic cellulosic fibers (e.g., paper fiber—such as newspaper, hemp fiber, jute fiber, flax fiber, wood fiber, or other natural fibers), protein fibers (e.g., sheep wool), and combinations thereof. Depending on the specific type of material, the fibrous component may either be hydrophilic (e.g., macroscopic cellulosic fibers) or hydrophobic (e.g., fiberglass, mineral wool, rock wool, stone wool).

The fibrous component may be present in an amount ranging from about 10 wt. % to about 80 wt. % based on the total dry weight of the body 120—including all values and sub-ranges there-between. For example, in some embodiments, the fibrous component may be present in an amount ranging from about 10 wt. % to about 80 wt. %, from about 15 wt. % to about 80 wt. %, from about 20 wt. % to about 80 wt. %, from about 25 wt. % to about 80 wt. %, from about 30 wt. % to about 80 wt. %, from about 35 wt. % to about 80 wt. %, from about 40 wt. % to about 80 wt. %, from about 45 wt. % to about 80 wt. %, from about 50 wt. % to about 80 wt. %, from about 55 wt. % to about 80 wt. %, from about 60 wt. % to about 80 wt. %, from about 65 wt. % to about 80 wt. %, from about 70 wt. % to about 80 wt. %, from about 75 wt. % to about 80 wt. %, from about 10 wt. % to about 75 wt. %, from about 15 wt. % to about 75 wt. %, from about 20 wt. % to about 75 wt. %, from about 25 wt. % to about 75 wt. %, from about 30 wt. % to about 75 wt. %, from about 35 wt. % to about 75 wt. %, from about 40 wt. % to about 75 wt. %, from about 45 wt. % to about 75 wt. %, from about 50 wt. % to about 75 wt. %, from about 55 wt. % to about 75 wt. %, from about 60 wt. % to about 75 wt. %, from about 65 wt. % to about 75 wt. %, from about 70 wt. % to about 75 wt. %, from about 10 wt. % to about 70 wt. %, from about 15 wt. % to about 70 wt. %, from about 20 wt. % to about 70 wt. %, from about 25 wt. % to about 70 wt. %, from about 30 wt. % to about 70 wt. %, from about 35 wt. % to about 70 wt. %, from about 40 wt. % to about 70 wt. %, from about 45 wt. % to about 70 wt. %, from about 50 wt. % to about 70 wt. %, from about 55 wt. % to about 70 wt. %, from about 60 wt. % to about 70 wt. %, from about 65 wt. % to about 70 wt. %, from about 10 wt. % to about 65 wt. %, from about 15 wt. % to about 65 wt. %, from about 20 wt. % to about 65 wt. %, from about 25 wt. % to about 65 wt. %, from about 30 wt. % to about 65 wt. %, from about 35 wt. % to about 65 wt. %, from about 40 wt. % to about 65 wt. %, from about 45 wt. % to about 65 wt. %, from about 50 wt. % to about 65 wt. %, from about 55 wt. % to about 65 wt. %, from about 60 wt. % to about 65 wt. %, from about 10 wt. % to about 60 wt. %, from about 15 wt. % to about 60 wt. %, from about 20 wt. % to about 60 wt. %, from about 25 wt. % to about 60 wt. %, from about 30 wt. % to about 60 wt. %, from about 35 wt. % to about 60 wt. %, from about 40 wt. % to about 60 wt. %, from about 45 wt. % to about 60 wt. %, from about 50 wt. % to about 60 wt. %, from about 55 wt. % to about 60 wt. %, from about 10 wt. % to about 55 wt. %, from about 15 wt. % to about 55 wt. %, from about 20 wt. % to about 55 wt. %, from about 25 wt. % to about 55 wt. %, from about 30 wt. % to about 55 wt. %, from about 35 wt. % to about 55 wt. %, from about 40 wt. % to about 55 wt. %, from about 45 wt. % to about 55 wt. %, from about 50 wt. % to about 55 wt. %, from about 10 wt. % to about 50 wt. %, from about 15 wt. % to about 50 wt. %, from about 20 wt. % to about 50 wt. %, from about 25 wt. % to about 50 wt. %, from about 30 wt. % to about 50 wt. %, from about 35 wt. % to about 50 wt. %, from about 40 wt. % to about 50 wt. %, from about 45 wt. % to about 50 wt. %, from about 10 wt. % to about 45 wt. %, from about 15 wt. % to about 45 wt. %, from about 20 wt. % to about 45 wt. %, from about 25 wt. % to about 45 wt. %, from about 30 wt. % to about 45 wt. %, from about 35 wt. % to about 45 wt. %, from about 40 wt. % to about 45 wt. %, from about 10 wt. % to about 40 wt. %, from about 15 wt. % to about 40 wt. %, from about 20 wt. % to about 40 wt. %, from about 25 wt. % to about 40 wt. %, from about 30 wt. % to about 40 wt. %, from about 35 wt. % to about 40 wt. %, from about 10 wt. % to about 35 wt. %, from about 15 wt. % to about 35 wt. %, from about 20 wt. % to about 35 wt. %, from about 25 wt. % to about 35 wt. %, from about 30 wt. % to about 35 wt. %, from about 10 wt. % to about 30 wt. %, from about 15 wt. % to about 30 wt. %, from about 20 wt. % to about 30 wt. %, from about 25 wt. % to about 30 wt. %, from about 10 wt. % to about 25 wt. %, from about 15 wt. % to about 25 wt. %, from about 20 wt. % to about 25 wt. %, from about 10 wt. % to about 20 wt. %, from about 15 wt. % to about 20 wt. %, from about 10 wt. % to about 15 wt. %, or any other suitable values and sub-ranges there-between, based on the total dry weight of the body 120.

The phrase “dry-weight” refers to the weight of a referenced component without the weight of any carrier. Thus, when calculating the weight percentages of components in the dry-state, the calculation should be based solely on the solid components (e.g., fibers, binder, biochar, flame retardant, filler, additive, etc.) and should exclude any amount of residual carrier (e.g., water, VOC solvent) that may still be present from a wet-state, which will be discussed further herein. According to the present invention, the phrase “dry-state” may also be used to indicate a component that is substantially free of a carrier, as compared to the term “wet-state,” which refers to that component still containing various amounts of carrier—as discussed further herein.

In some embodiments, the fibrous component may be inorganic fiber, such as mineral wool, whereby the inorganic fiber may be present in an amount ranging from about 5 wt. % to about 75 wt. %—including all weight percentages and sub-ranges there-between—based on the total weight of the body 120. For example, in some embodiments, the inorganic fiber may be present in an amount ranging from about 5 wt. % to about 75 wt. %, from about 10 wt. % to about 75 wt. %, from about 15 wt. % to about 75 wt. %, from about 20 wt. % to about 75 wt. %, from about 25 wt. % to about 75 wt. %, from about 30 wt. % to about 75 wt. %, from about 35 wt. % to about 75 wt. %, from about 40 wt. % to about 75 wt. %, from about 45 wt. % to about 75 wt. %, from about 50 wt. % to about 75 wt. %, from about 55 wt. % to about 75 wt. %, from about 60 wt. % to about 75 wt. %, from about 65 wt. % to about 75 wt. %, from about 70 wt. % to about 75 wt. %, from about 5 wt. % to about 70 wt. %, from about 10 wt. % to about 70 wt. %, from about 15 wt. % to about 70 wt. %, from about 20 wt. % to about 70 wt. %, from about 25 wt. % to about 70 wt. %, from about 30 wt. % to about 70 wt. %, from about 35 wt. % to about 70 wt. %, from about 40 wt. % to about 70 wt. %, from about 45 wt. % to about 70 wt. %, from about 50 wt. % to about 70 wt. %, from about 55 wt. % to about 70 wt. %, from about 60 wt. % to about 70 wt. %, from about 65 wt. % to about 70 wt. %, from about 5 wt. % to about 65 wt. %, from about 10 wt. % to about 65 wt. %, from about 15 wt. % to about 65 wt. %, from about 20 wt. % to about 65 wt. %, from about 25 wt. % to about 65 wt. %, from about 30 wt. % to about 65 wt. %, from about 35 wt. % to about 65 wt. %, from about 40 wt. % to about 65 wt. %, from about 45 wt. % to about 65 wt. %, from about 50 wt. % to about 65 wt. %, from about 55 wt. % to about 65 wt. %, from about 60 wt. % to about 65 wt. %, from about 5 wt. % to about 60 wt. %, from about 10 wt. % to about 60 wt. %, from about 15 wt. % to about 60 wt. %, from about 20 wt. % to about 60 wt. %, from about 25 wt. % to about 60 wt. %, from about 30 wt. % to about 60 wt. %, from about 35 wt. % to about 60 wt. %, from about 40 wt. % to about 60 wt. %, from about 45 wt. % to about 60 wt. %, from about 50 wt. % to about 60 wt. %, from about 55 wt. % to about 60 wt. %, from about 5 wt. % to about 55 wt. %, from about 10 wt. % to about 55 wt. %, from about 15 wt. % to about 55 wt. %, from about 20 wt. % to about 55 wt. %, from about 25 wt. % to about 55 wt. %, from about 30 wt. % to about 55 wt. %, from about 35 wt. % to about 55 wt. %, from about 40 wt. % to about 55 wt. %, from about 45 wt. % to about 55 wt. %, from about 50 wt. % to about 55 wt. %, from about 5 wt. % to about 50 wt. %, from about 10 wt. % to about 50 wt. %, from about 15 wt. % to about 50 wt. %, from about 20 wt. % to about 50 wt. %, from about 25 wt. % to about 50 wt. %, from about 30 wt. % to about 50 wt. %, from about 35 wt. % to about 50 wt. %, from about 40 wt. % to about 50 wt. %, from about 45 wt. % to about 50 wt. %, from about 5 wt. % to about 45 wt. %, from about 10 wt. % to about 45 wt. %, from about 15 wt. % to about 45 wt. %, from about 20 wt. % to about 45 wt. %, from about 25 wt. % to about 45 wt. %, from about 30 wt. % to about 45 wt. %, from about 35 wt. % to about 45 wt. %, from about 40 wt. % to about 45 wt. %, from about 5 wt. % to about 40 wt. %, from about 10 wt. % to about 40 wt. %, from about 15 wt. % to about 40 wt. %, from about 20 wt. % to about 40 wt. %, from about 25 wt. % to about 40 wt. %, from about 30 wt. % to about 40 wt. %, from about 35 wt. % to about 40 wt. %, from about 5 wt. % to about 35 wt. %, from about 10 wt. % to about 35 wt. %, from about 15 wt. % to about 35 wt. %, from about 20 wt. % to about 35 wt. %, from about 25 wt. % to about 35 wt. %, from about 30 wt. % to about 35 wt. %, from about 5 wt. % to about 30 wt. %, from about 10 wt. % to about 30 wt. %, from about 15 wt. % to about 30 wt. %, from about 20 wt. % to about 30 wt. %, from about 25 wt. % to about 30 wt. %, from about 5 wt. % to about 25 wt. %, from about 10 wt. % to about 25 wt. %, from about 15 wt. % to about 25 wt. %, from about 20 wt. % to about 25 wt. %, from about 5 wt. % to about 20 wt. %, from about 10 wt. % to about 20 wt. %, from about 15 wt. % to about 20 wt. %, from about 5 wt. % to about 15 wt. %, from about 10 wt. % to about 15 wt. %, from about 5 wt. % to about 10 wt. %, or any other suitable weight percentages and sub-ranges there-between, based on the total weight of the body 120.

In some embodiments, the fibrous component may further include macroscopic cellulosic fiber, such as recycled newspaper. In some embodiments, the cellulosic fiber may be present in an amount ranging from about 3 wt. % to about 25 wt. %—including all weight percentages and sub-ranges there-between—based on the total weight of the body 120. For example, in some embodiments, the cellulosic fiber may be present in an amount ranging from about 3 wt. % to about 25 wt. %, from about 5 wt. % to about 25 wt. %, from about 10 wt. % to about 25 wt. %, from about 15 wt. % to about 25 wt. %, from about 20 wt. % to about 25 wt. %, 3 wt. % to about 20 wt. %, from about 5 wt. % to about 20 wt. %, from about 10 wt. % to about 20 wt. %, from about 15 wt. % to about 20 wt. %, 3 wt. % to about 15 wt. %, from about 5 wt. % to about 15 wt. %, from about 10 wt. % to about 15 wt. %, 3 wt. % to about 10 wt. %, from about 5 wt. % to about 10 wt. %, 3 wt. % to about 5 wt. %, or any other suitable weight percentages and sub-ranges there-between, based on the total weight of the body 120.

In some embodiments, the body 120 may further comprise biochar. The term biochar may be interchangeable with the term “biocoal” and refers to pyrolyzed biomass. Biochar production removes carbon dioxide directly from the atmosphere through uptake by plants—thereby allowing an actual reduction of atmospheric carbon dioxide levels. With this in mind, the creation of acoustic panels comprising a body formed, in part, of biochar helps reduce carbon footprint and thereby alleviate global warming potential as biochar is a carbon negative material—i.e., production eliminates CO₂ from the atmosphere.

In some embodiments, the biochar may be present in an amount ranging from about 5 wt. % to about 50 wt. % based on the total dry weight of the body 120—including all values and sub-ranges there-between. For example, in some embodiments, the biochar may be present in an amount ranging from about 5 wt. % to about 50 wt. %, from about 10 wt. % to about 50 wt. %, from about 15 wt. % to about 50 wt. %, from about 20 wt. % to about 50 wt. %, from about 25 wt. % to about 50 wt. %, from about 30 wt. % to about 50 wt. %, from about 35 wt. % to about 50 wt. %, from about 40 wt. % to about 50 wt. %, from about 45 wt. %, to about 50 wt. %, from about 5 wt. % to about 45 wt. %, from about 10 wt. % to about 45 wt. %, from about 15 wt. % to about 45 wt. %, from about 20 wt. % to about 45 wt. %, from about 25 wt. % to about 45 wt. %, from about 30 wt. % to about 45 wt. %, from about 35 wt. % to about 45 wt. %, from about 40 wt. % to about 45 wt. %, from about 5 wt. % to about 40 wt. %, from about 10 wt. % to about 40 wt. %, from about 15 wt. % to about 40 wt. %, from about 20 wt. % to about 40 wt. %, from about 25 wt. % to about 40 wt. %, from about 30 wt. % to about 40 wt. %, from about 35 wt. % to about 40 wt. %, from about 5 wt. % to about 35 wt. %, from about 10 wt. % to about 35 wt. %, from about 15 wt. % to about 35 wt. %, from about 20 wt. % to about 35 wt. %, from about 25 wt. % to about 35 wt. %, from about 30 wt. % to about 35 wt. %, from about 5 wt. % to about 30 wt. %, from about 10 wt. % to about 30 wt. %, from about 15 wt. % to about 30 wt. %, from about 20 wt. % to about 30 wt. %, from about 25 wt. % to about 30 wt. %, from about 5 wt. % to about 25 wt. %, from about 10 wt. % to about 25 wt. %, from about 15 wt. % to about 25 wt. %, from about 20 wt. % to about 25 wt. %, from about 5 wt. % to about 20 wt. %, from about 10 wt. % to about 20 wt. %, from about 15 wt. % to about 20 wt. %, from about 5 wt. % to about 15 wt. %, from about 10 wt. % to about 15 wt. %, from about 5 wt. % to about 10 wt. %, or any other suitable values and sub-ranges there-between, based on the total dry weight of the body 120. In some embodiments, the biochar may be present in an amount ranging from about 10 wt. % to about 40 wt. % based on the total dry weight of the body 120—including all values and sub-ranges there-between.

In some embodiments, the biochar may have a density ranging from about 3 pounds per cubic foot (pcf) to about 36 pcf. For example, in some embodiments, the biochar may have a density ranging from about 3 pounds per cubic foot (pcf) to about 36 pcf, from about 5 pcf to about 36 pcf, from about 10 pcf to about 36 pcf, from about 15 pcf to about 36 pcf, from about 20 pcf to about 36 pcf, from about 25 pcf to about 36 pcf, from about 30 pcf to about 36 pcf, from about 3 pcf to about 30 pcf, from about 5 pcf to about 30 pcf, from about 10 pcf to about 30 pcf, from about 15 pcf to about 30 pcf, from about 20 pcf to about 30 pcf, from about 25 pcf to about 30 pcf, from about 3 pcf to about 25 pcf, from about 5 pcf to about 25 pcf, from about 10 pcf to about 25 pcf, from about 15 pcf to about 25 pcf, from about 20 pcf to about 25 pcf, from about 3 pcf to about 20 pcf, from about 5 pcf to about 20 pcf, from about 10 pcf to about 20 pcf, from about 15 pcf to about 20 pcf, from about 3 pcf to about 15 pcf, from about 5 pcf to about 15 pcf, from about 10 pcf to about 15 pcf, from about 3 pcf to about 10 pcf, from about 5 pcf to about 10 pcf, from about 3 pcf to about 5 pcf, or any other suitable values or sub-ranges there-between.

In some embodiments, the biochar may have a density ranging from about 3 pcf to about 18 pcf. For example, in some embodiments, the biochar may have a density ranging from about 3 pcf to about 18 pcf, from about 5 pcf to about 18 pcf, from about 7 pcf to about 18 pcf, from about 9 pcf to about 18 pcf, from about 11 pcf to about 18 pcf, from about 13 pcf to about 18 pcf, from about 15 pcf to about 18 pcf, from about 17 pcf to about 18 pcf, from about 3 pcf to about 17 pcf, from about 5 pcf to about 17 pcf, from about 7 pcf to about 17 pcf, from about 9 pcf to about 17 pcf, from about 11 pcf to about 17 pcf, from about 13 pcf to about 17 pcf, from about 15 pcf to about 17 pcf, from about 3 pcf to about 15 pcf, from about 5 pcf to about 15 pcf, from about 7 pcf to about 15 pcf, from about 9 pcf to about 15 pcf, from about 11 pcf to about 15 pcf, from about 13 pcf to about 15 pcf, from about 3 pcf to about 13 pcf, from about 5 pcf to about 13 pcf, from about 7 pcf to about 13 pcf, from about 9 pcf to about 13 pcf, from about 11 pcf to about 13 pcf, from about 3 pcf to about 11 pcf, from about 5 pcf to about 11 pcf, from about 7 pcf to about 11 pcf, from about 9 pcf to about 11 pcf, from about 3 pcf to about 9 pcf, from about 5 pcf to about 9 pcf, from about 7 pcf to about 9 pcf, from about 3 pcf to about 7 pcf, from about 5 pcf to about 7 pcf, from about 3 pcf to about 5 pcf, or any other suitable values or sub-ranges there-between.

The biochar may be machined to a specific particle size distribution. The biochar may have an average particle size ranging from about 0.1 mm to about 5 mm—including all sizes and sub-ranges there-between. For example, in some embodiments, the biochar may have an average particle size ranging from about 0.1 mm to about 5 mm, from about 0.5 mm to about 5 mm, from about 1 mm to about 5 mm, from about 1.5 mm to about 5 mm, from about 2 mm to about 5 mm, from about 2.5 mm to about 5 mm, from about 3 mm to about 5 mm, from about 3.5 mm to about 5 mm, from about 4 mm to about 5 mm, from about 4.5 mm to about 5 mm, from about 0.1 mm to about 4.5 mm, from about 0.5 mm to about 4.5 mm, from about 1 mm to about 4.5 mm, from about 1.5 mm to about 4.5 mm, from about 2 mm to about 4.5 mm, from about 2.5 mm to about 4.5 mm, from about 3 mm to about 4.5 mm, from about 3.5 mm to about 4.5 mm, from about 4 mm to about 4.5 mm, from about 0.1 mm to about 4 mm, from about 0.5 mm to about 4 mm, from about 1 mm to about 4 mm, from about 1.5 mm to about 4 mm, from about 2 mm to about 4 mm, from about 2.5 mm to about 4 mm, from about 3 mm to about 4 mm, from about 3.5 mm to about 4 mm, from about 0.1 mm to about 3.5 mm, from about 0.5 mm to about 3.5 mm, from about 1 mm to about 3.5 mm, from about 1.5 mm to about 3.5 mm, from about 2 mm to about 3.5 mm, from about 2.5 mm to about 3.5 mm, from about 3 mm to about 3.5 mm, from about 0.1 mm to about 3 mm, from about 0.5 mm to about 3 mm, from about 1 mm to about 3 mm, from about 1.5 mm to about 3 mm, from about 2 mm to about 3 mm, from about 2.5 mm to about 3 mm, from about 0.1 mm to about 2.5 mm, from about 0.5 mm to about 2.5 mm, from about 1 mm to about 2.5 mm, from about 1.5 mm to about 2.5 mm, from about 2 mm to about 2.5 mm, from about 0.1 mm to about 2 mm, from about 0.5 mm to about 2 mm, from about 1 mm to about 2 mm, from about 1.5 mm to about 2 mm, from about 0.1 mm to about 1.5 mm, from about 0.5 mm to about 1.5 mm, from about 1 mm to about 1.5 mm, from about 0.1 mm to about 1 mm, from about 0.5 mm to about 1 mm, from about 0.1 mm to about 0.5 mm, or any other suitable values or sub-ranges there-between.

It has been surprisingly discovered that the addition of one or more flame retardants according to the present invention may impart enhanced self-extinguishing characteristics to the biochar-containing body 120 and the resulting building panel. The self-extinguishing characteristics may unexpectedly reduce smoldering of the body 120 in high-heat environments—i.e., reduce burning of the body 120 without the presence of an open flame.

In some embodiments, the body 120 may include a flame retardant present in the body 120 in an amount ranging from about 1 wt. % to about 25 wt. %, such as from about 5 wt. % to about 20 wt. %, based on the total dry weight of the body 120—including all values and sub-ranges therebetween. For example, in some embodiments, the body 120 may include a flame retardant present in the body 120 in an amount ranging from about 1 wt. % to about 25 wt. %, from about 5 wt. % to about 25 wt. %, from about 10 wt. % to about 25 wt. %, from about 15 wt. % to about 25 wt. %, from about 20 wt. % to about 25 wt. %, from about 1 wt. % to about 20 wt. %, from about 5 wt. % to about 20 wt. %, from about 10 wt. % to about 20 wt. %, from about 15 wt. % to about 20 wt. %, from about 1 wt. % to about 15 wt. %, from about 5 wt. % to about 15 wt. %, from about 10 wt. % to about 15 wt. %, from about 1 wt. % to about 10 wt. %, from about 5 wt. % to about 10 wt. %, from about 1 wt. % to about 5 wt. %, or any other suitable values and sub-ranges therebetween, based on the total dry weight of the body 120.

In some embodiments, the flame retardant may have an average particle size ranging from about 1 μm to about 100 μm—including all values and sub-ranges there-between. For example, in some embodiments, the flame retardant may have an average particle size ranging from about 1 μm to about 100 μm, from about 25 μm to about 100 μm, from about 50 μm to about 100 μm, from about 75 μm to about 100 μm, from about 1 μm to about 75 μm, from about 25 μm to about 75 μm, from about 50 μm to about 75 μm, from about 1 μm to about 50 μm, from about 25 μm to about 50 μm, from about 1 μm to about 25 μm, or any other suitable values or sub-ranges there-between.

In some embodiments, the flame retardant may include an active filler flame retardants. In some embodiments, the term active filler flame retardant may refer to a flame retardant that may decompose at an elevated temperature ranging from about 200° C. to about 325° C. Depending on the particular active filler flame retardant, in some embodiments, the active filler flame retardant may decompose at an elevated temperature ranging from about 200° C. to about 325° C., from about 225° C. to about 325° C., from about 250° C. to about 325° C., from about 275° C. to about 325° C., from about 300° C. to about 325° C., 200° C. to about 300° C., from about 225° C. to about 300° C., from about 250° C. to about 300° C., from about 275° C. to about 300° C., 200° C. to about 275° C., from about 225° C. to about 275° C., from about 250° C. to about 275° C., 200° C. to about 250° C., from about 225° C. to about 250° C., 200° C. to about 225° C., or any other suitable values or sub-ranges there-between. In some embodiments, the active filler flame retardant may decompose endothermically and absorb heat from the surroundings. Thus, in some embodiments, the active filler flame retardant may function as a heat sink. In some embodiments, upon decomposition, the flame retardant may emit water (H₂O), such as water vapor.

Non-limiting example of the flame retardant may include colemanite, aluminum hydroxide, magnesium hydroxide, bochmite, hydrous or calcined clay, calcium carbonate, talc, feldspar, or a combination of two or more thereof.

As discussed above, the phrase “dry-weight” used herein refers to the weight of a referenced component without the weight of any carrier. It should be noted that the term “carrier” refers to a liquid carrier not as part of a hydrous component, such as some of the hydrous flame retardants discussed above. Such liquid carrier may be capable of evaporation from a mixture or blend during a drying or hardening process at a temperature ranging from about 60° C. to about 200° C. as discussed further herein. However, the hydrous compound may not lose its hydration during such drying or hardening process. Thus, when calculating the weight percentages of the hydrous component, such as the weight percentage of the flame retardant in the dry-state, the calculation is based on the weight of the hydrous component (including hydration that may not evaporate in the drying or hardening process) and the weight of the body 120 without any liquid carrier that is capable of evaporation from the body 120 during the drying or hardening process.

In some embodiments, the fibers 130 of the present invention may comprise the inorganic fiber and the organic fiber in a weight ratio ranging from about 1:2 to about 15:1—including all values and sub-ranges there-between. For example, in some embodiments, the fibers 130 of the present invention may comprise the inorganic fiber and the organic fiber in a weight ratio ranging from about 1:2 to about 15:1, from about 1:1 to about 15:1, from about 3:1 to about 15:1, from about 5:1 to about 15:1, from about 7:1 to about 15:1, from about 9:1 to about 15:1, from about 11:1 to about 15:1, from about 13:1 to about 15:1, from about 1:2 to about 13:1, from about 1:1 to about 13:1, from about 3:1 to about 13:1, from about 5:1 to about 13:1, from about 7:1 to about 13:1, from about 9:1 to about 13:1, from about 11:1 to about 13:1, from about 1:2 to about 11:1, from about 1:1 to about 11:1, from about 3:1 to about 11:1, from about 5:1 to about 11:1, from about 7:1 to about 11:1, from about 9:1 to about 11:1, from about 1:2 to about 9:1, from about 1:1 to about 9:1, from about 3:1 to about 9:1, from about 5:1 to about 9:1, from about 7:1 to about 9:1, from about 1:2 to about 7:1, from about 1:1 to about 7:1, from about 3:1 to about 7:1, from about 5:1 to about 7:1, from about 1:2 to about 5:1, from about 1:1 to about 5:1, from about 3:1 to about 5:1, from about 1:2 to about 3:1, from about 1:1 to about 3:1, from about 1:2 to about 1:1, or any other suitable values and sub-ranges there-between.

In some embodiments, the fibers 130 and the biochar may be present in a weight ratio ranging from about 1:1 to about 10:1—including all values and sub-ranges there-between. For example, in some embodiments, the fibers 130 and the biochar may be present in a weight ratio ranging from about 1:1 to about 10:1, from about 2:1 to about 10:1, from about 3:1 to about 10:1, from about 4:1 to about 10:1, from about 5:1 to about 10:1, from about 6:1 to about 10:1, from about 7:1 to about 10:1, from about 8:1 to about 10:1, from about 9:1 to about 10:1, from about 1:1 to about 9:1, from about 2:1 to about 9:1, from about 3:1 to about 9:1, from about 4:1 to about 9:1, from about 5:1 to about 9:1, from about 6:1 to about 9:1, from about 7:1 to about 9:1, from about 8:1 to about 9:1, from about 1:1 to about 8:1, from about 2:1 to about 8:1, from about 3:1 to about 8:1, from about 4:1 to about 8:1, from about 5:1 to about 8:1, from about 6:1 to about 8:1, from about 7:1 to about 8:1, from about 1:1 to about 7:1, from about 2:1 to about 7:1, from about 3:1 to about 7:1, from about 4:1 to about 7:1, from about 5:1 to about 7:1, from about 6:1 to about 7:1, from about 1:1 to about 6:1, from about 2:1 to about 6:1, from about 3:1 to about 6:1, from about 4:1 to about 6:1, from about 5:1 to about 6:1, from about 1:1 to about 5:1, from about 2:1 to about 5:1, from about 3:1 to about 5:1, from about 4:1 to about 5:1, from about 1:1 to about 4:1, from about 2:1 to about 4:1, from about 3:1 to about 4:1, from about 1:1 to about 3:1, from about 2:1 to about 3:1, from about 1:1 to about 2:1, or any other suitable values and sub-ranges there-between.

In some embodiments, the inorganic fibers and the biochar may be present in a weight ratio ranging from about 1:1 to about 8:1—including all values and sub-ranges there-between. For example, in some embodiments, the inorganic fibers and the biochar may be present in a weight ratio ranging from about 1:1 to about 8:1, from about 2:1 to about 8:1, from about 3:1 to about 8:1, from about 4:1 to about 8:1, from about 5:1 to about 8:1, from about 6:1 to about 8:1, from about 7:1 to about 8:1, from about 1:1 to about 7:1, from about 2:1 to about 7:1, from about 3:1 to about 7:1, from about 4:1 to about 7:1, from about 5:1 to about 7:1, from about 6:1 to about 7:1, from about 1:1 to about 6:1, from about 2:1 to about 6:1, from about 3:1 to about 6:1, from about 4:1 to about 6:1, from about 5:1 to about 6:1, from about 1:1 to about 5:1, from about 2:1 to about 5:1, from about 3:1 to about 5:1, from about 4:1 to about 5:1, from about 1:1 to about 4:1, from about 2:1 to about 4:1, from about 3:1 to about 4:1, from about 1:1 to about 3:1, from about 2:1 to about 3:1, from about 1:1 to about 2:1, or any other suitable values and sub-ranges there-between.

In some embodiments, the organic fibers and the biochar may be present in a weight ratio ranging from about 1:2 to about 1:10—including all values and sub-ranges there-between. For example, in some embodiments, the organic fibers and the biochar may be present in a weight ratio ranging from about 1:2 to about 1:10, from about 1:3 to about 1:10, from about 1:4 to about 1:10, from about 1:5 to about 1:10, from about 1:6 to about 1:10, from about 1:7 to about 1:10, from about 1:8 to about 1:10, from about 1:9 to about 1:10, from about 1:2 to about 1:9, from about 1:3 to about 1:9, from about 1:4 to about 1:9, from about 1:5 to about 1:9, from about 1:6 to about 1:9, from about 1:7 to about 1:9, from about 1:8 to about 1:9, from about 1:2 to about 1:8, from about 1:3 to about 1:8, from about 1:4 to about 1:8, from about 1:5 to about 1:8, from about 1:6 to about 1:8, from about 1:7 to about 1:8, from about 1:2 to about 1:7, from about 1:3 to about 1:7, from about 1:4 to about 1:7, from about 1:5 to about 1:7, from about 1:6 to about 1:7, from about 1:2 to about 1:6, from about 1:3 to about 1:6, from about 1:4 to about 1:6, from about 1:5 to about 1:6, from about 1:2 to about 1:5, from about 1:3 to about 1:5, from about 1:4 to about 1:5, from about 1:2 to about 1:4, from about 1:3 to about 1:4, from about 1:2 to about 1:3, or any other suitable values and sub-ranges there-between.

In some embodiments, the biochar and the flame retardant may be present in a weight ratio ranging from about 1:1 to about 6:1, such as from about 1:1 to about 4:1, including all values and sub-ranges there-between. The building panels described herein may allow high biochar-to-flame-retardant weight ratios to be implemented to keep the manufacturing cost low while maintaining desirable fire resistance. For example, in some embodiments, the biochar and the flame retardant may be present in a weight ratio ranging from about 1:1 to about 6:1, from about 2:1 to about 6:1, from about 3:1 to about 6:1, from about 4:1 to about 6:1, from about 5:1 to about 6:1, from about 1:1 to about 5:1, from about 2:1 to about 5:1, from about 3:1 to about 5:1, from about 4:1 to about 5:1, from about 1:1 to about 4:1, from about 2:1 to about 4:1, from about 3:1 to about 4:1, from about 1:1 to about 3:1, from about 2:1 to about 3:1, from about 1:1 to about 2:1, or any other suitable values and sub-ranges there-between.

In some embodiments, the fibers and the flame retardant may be present in a weight ratio ranging from about 4:1 to about 16:1, such as from about 4:1 to about 12:1, including all values and sub-ranges there-between. For example, in some embodiments, the fibers and the flame retardant may be present in a weight ratio ranging from about 4:1 to about 16:1, from about 5:1 to about 16:1, from about 6:1 to about 16:1, from about 7:1 to about 16:1, from about 8:1 to about 16:1, from about 9:1 to about 16:1, from about 10:1 to about 16:1, from about 11:1 to about 16:1, from about 12:1 to about 16:1, from about 13:1 to about 16:1, from about 14:1 to about 16:1, from about 15:1 to about 16:1, from about 4:1 to about 15:1, from about 5:1 to about 15:1, from about 6:1 to about 15:1, from about 7:1 to about 15:1, from about 8:1 to about 15:1, from about 9:1 to about 15:1, from about 10:1 to about 15:1, from about 11:1 to about 15:1, from about 12:1 to about 15:1, from about 13:1 to about 15:1, from about 14:1 to about 15:1, from about 4:1 to about 14:1, from about 5:1 to about 14:1, from about 6:1 to about 14:1, from about 7:1 to about 14:1, from about 8:1 to about 14:1, from about 9:1 to about 14:1, from about 10:1 to about 14:1, from about 11:1 to about 14:1, from about 12:1 to about 14:1, from about 13:1 to about 14:1, from about 4:1 to about 13:1, from about 5:1 to about 13:1, from about 6:1 to about 13:1, from about 7:1 to about 13:1, from about 8:1 to about 13:1, from about 9:1 to about 13:1, from about 10:1 to about 13:1, from about 11:1 to about 13:1, from about 12:1 to about 13:1, from about 4:1 to about 12:1, from about 5:1 to about 12:1, from about 6:1 to about 12:1, from about 7:1 to about 12:1, from about 8:1 to about 12:1, from about 9:1 to about 12:1, from about 10:1 to about 12:1, from about 11:1 to about 12:1, from about 4:1 to about 11:1, from about 5:1 to about 11:1, from about 6:1 to about 11:1, from about 7:1 to about 11:1, from about 8:1 to about 11:1, from about 9:1 to about 11:1, from about 10:1 to about 11:1, from about 4:1 to about 10:1, from about 5:1 to about 10:1, from about 6:1 to about 10:1, from about 7:1 to about 10:1, from about 8:1 to about 10:1, from about 9:1 to about 10:1, from about 4:1 to about 9:1, from about 5:1 to about 9:1, from about 6:1 to about 9:1, from about 7:1 to about 9:1, from about 8:1 to about 9:1, from about 4:1 to about 8:1, from about 5:1 to about 8:1, from about 6:1 to about 8:1, from about 7:1 to about 8:1, from about 4:1 to about 7:1, from about 5:1 to about 7:1, from about 6:1 to about 7:1, from about 4:1 to about 6:1, from about 5:1 to about 6:1, from about 4:1 to about 5:1, or any other suitable values and sub-ranges there-between.

In some embodiments, the inorganic fibers and the flame retardant may be present in a weight ratio ranging from about 2:1 to about 15:1—including all values and sub-ranges there-between. For example, in some embodiments, the inorganic fibers and the flame retardant may be present in a weight ratio ranging from about 2:1 to about 15:1, from about 3:1 to about 15:1, from about 4:1 to about 15:1, from about 5:1 to about 15:1, from about 6:1 to about 15:1, from about 7:1 to about 15:1, from about 8:1 to about 15:1, from about 9:1 to about 15:1, from about 10:1 to about 15:1, from about 11:1 to about 15:1, from about 12:1 to about 15:1, from about 13:1 to about 15:1, from about 14:1 to about 15:1, from about 2:1 to about 14:1, from about 3:1 to about 14:1, from about 4:1 to about 14:1, from about 5:1 to about 14:1, from about 6:1 to about 14:1, from about 7:1 to about 14:1, from about 8:1 to about 14:1, from about 9:1 to about 14:1, from about 10:1 to about 14:1, from about 11:1 to about 14:1, from about 12:1 to about 14:1, from about 13:1 to about 14:1, from about 2:1 to about 13:1, from about 3:1 to about 13:1, from about 4:1 to about 13:1, from about 5:1 to about 13:1, from about 6:1 to about 13:1, from about 7:1 to about 13:1, from about 8:1 to about 13:1, from about 9:1 to about 13:1, from about 10:1 to about 13:1, from about 11:1 to about 13:1, from about 12:1 to about 13:1, from about 2:1 to about 12:1, from about 3:1 to about 12:1, from about 4:1 to about 12:1, from about 5:1 to about 12:1, from about 6:1 to about 12:1, from about 7:1 to about 12:1, from about 8:1 to about 12:1, from about 9:1 to about 12:1, from about 10:1 to about 12:1, from about 11:1 to about 12:1, from about 2:1 to about 11:1, from about 3:1 to about 11:1, from about 4:1 to about 11:1, from about 5:1 to about 11:1, from about 6:1 to about 11:1, from about 7:1 to about 11:1, from about 8:1 to about 11:1, from about 9:1 to about 11:1, from about 10:1 to about 11:1, from about 2:1 to about 10:1, from about 3:1 to about 10:1, from about 4:1 to about 10:1, from about 5:1 to about 10:1, from about 6:1 to about 10:1, from about 7:1 to about 10:1, from about 8:1 to about 10:1, from about 9:1 to about 10:1, from about 2:1 to about 9:1, from about 3:1 to about 9:1, from about 4:1 to about 9:1, from about 5:1 to about 9:1, from about 6:1 to about 9:1, from about 7:1 to about 9:1, from about 8:1 to about 9:1, from about 2:1 to about 8:1, from about 3:1 to about 8:1, from about 4:1 to about 8:1, from about 5:1 to about 8:1, from about 6:1 to about 8:1, from about 7:1 to about 8:1, from about 2:1 to about 7:1, from about 3:1 to about 7:1, from about 4:1 to about 7:1, from about 5:1 to about 7:1, from about 6:1 to about 7:1, from about 2:1 to about 6:1, from about 3:1 to about 6:1, from about 4:1 to about 6:1, from about 5:1 to about 6:1, from about 2:1 to about 5:1, from about 3:1 to about 5:1, from about 4:1 to about 5:1, from about 2:1 to about 4:1, from about 3:1 to about 4:1, from about 2:1 to about 3:1, or any other suitable values and sub-ranges there-between.

In some embodiments, the organic fibers and the flame retardant may be present in a weight ratio ranging from about 1:1 to about 5:1—including all values and sub-ranges there-between. For example, in some embodiments, the organic fibers and the flame retardant may be present in a weight ratio ranging from about 1:1 to about 5:1, from about 2:1 to about 5:1, from about 3:1 to about 5:1, from about 4:1 to about 5:1, from about 1:1 to about 4:1, from about 2:1 to about 4:1, from about 3:1 to about 4:1, from about 1:1 to about 3:1, from about 2:1 to about 3:1, from about 1:1 to about 2:1, or any other suitable values and sub-ranges there-between.

In some embodiments, the body 120 may further comprise a binder. Non-limiting examples of binder may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof.

In some embodiments, the binder may be present in an amount ranging from about 3 wt. % to about 15 wt. % based on the total dry weight of the body 120—including all values and sub-ranges there-between. For example, in some embodiments, the binder may be present in an amount ranging from about 3 wt. % to about 15 wt. %, from about 6 wt. % to about 15 wt. %, from about 9 wt. % to about 15 wt. %, from about 12 wt. % to about 15 wt. %, from about 3 wt. % to about 12 wt. %, from about 6 wt. % to about 12 wt. %, from about 9 wt. % to about 12 wt. %, from about 3 wt. % to about 9 wt. %, from about 6 wt. % to about 9 wt. %, from about 3 wt. % to about 6 wt. %, or any other suitable values and sub-ranges there-between, based on the total dry weight of the body 120.

In some embodiments, the binder may include a starch-based polymer. In some embodiments, the starch-based polymer may be present in an amount ranging from about 3 wt. % to about 10 wt. % based on the total dry weight of the body 120—including all values and sub-ranges there-between. For example, in some embodiments, the starch-based polymer may be present in an amount ranging from about 3 wt. % to about 10 wt. %, from about 5 wt. % to about 10 wt. %, from about 7 wt. % to about 10 wt. %, from about 9 wt. % to about 10 wt. %, from about 3 wt. % to about 9 wt. %, from about 5 wt. % to about 9 wt. %, from about 7 wt. % to about 9 wt. %, from about 3 wt. % to about 7 wt. %, from about 5 wt. % to about 7 wt. %, from about 3 wt. % to about 5 wt. %, or any other suitable values and sub-ranges there-between, based on the total dry weight of the body 120.

In some embodiments, the body 120 may further comprise a filler. Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

In some embodiments, the filler may be present in an amount ranging from about 2 wt. % to about 60 wt. %, such as from about 2 wt. % to about 50 wt. %, based on the total dry weight of the body 120—including all values and sub-ranges there-between. For example, in some embodiments, the filler may be present in an amount ranging from about 2 wt. % to about 60 wt. %, from about 5 wt. % to about 60 wt. %, from about 10 wt. % to about 60 wt. %, from about 15 wt. % to about 60 wt. %, from about 20 wt. % to about 60 wt. %, from about 25 wt. % to about 60 wt. %, from about 30 wt. % to about 60 wt. %, from about 35 wt. % to about 60 wt. %, from about 40 wt. % to about 60 wt. %, from about 45 wt. % to about 60 wt. %, from about 50 wt. % to about 60 wt. %, from about 55 wt. % to about 60 wt. %, from about 2 wt. % to about 55 wt. %, from about 5 wt. % to about 55 wt. %, from about 10 wt. % to about 55 wt. %, from about 15 wt. % to about 55 wt. %, from about 20 wt. % to about 55 wt. %, from about 25 wt. % to about 55 wt. %, from about 30 wt. % to about 55 wt. %, from about 35 wt. % to about 55 wt. %, from about 40 wt. % to about 55 wt. %, from about 45 wt. % to about 55 wt. %, from about 50 wt. % to about 55 wt. %, from about 2 wt. % to about 50 wt. %, from about 5 wt. % to about 50 wt. %, from about 10 wt. % to about 50 wt. %, from about 15 wt. % to about 50 wt. %, from about 20 wt. % to about 50 wt. %, from about 25 wt. % to about 50 wt. %, from about 30 wt. % to about 50 wt. %, from about 35 wt. % to about 50 wt. %, from about 40 wt. % to about 50 wt. %, from about 45 wt. % to about 50 wt. %, from about 2 wt. % to about 45 wt. %, from about 5 wt. % to about 45 wt. %, from about 10 wt. % to about 45 wt. %, from about 15 wt. % to about 45 wt. %, from about 20 wt. % to about 45 wt. %, from about 25 wt. % to about 45 wt. %, from about 30 wt. % to about 45 wt. %, from about 35 wt. % to about 45 wt. %, from about 40 wt. % to about 45 wt. %, from about 2 wt. % to about 40 wt. %, from about 5 wt. % to about 40 wt. %, from about 10 wt. % to about 40 wt. %, from about 15 wt. % to about 40 wt. %, from about 20 wt. % to about 40 wt. %, from about 25 wt. % to about 40 wt. %, from about 30 wt. % to about 40 wt. %, from about 35 wt. % to about 40 wt. %, from about 2 wt. % to about 35 wt. %, from about 5 wt. % to about 35 wt. %, from about 10 wt. % to about 35 wt. %, from about 15 wt. % to about 35 wt. %, from about 20 wt. % to about 35 wt. %, from about 25 wt. % to about 35 wt. %, from about 30 wt. % to about 35 wt. %, from about 2 wt. % to about 30 wt. %, from about 5 wt. % to about 30 wt. %, from about 10 wt. % to about 30 wt. %, from about 15 wt. % to about 30 wt. %, from about 20 wt. % to about 30 wt. %, from about 25 wt. % to about 30 wt. %, from about 2 wt. % to about 25 wt. %, from about 5 wt. % to about 25 wt. %, from about 10 wt. % to about 25 wt. %, from about 15 wt. % to about 25 wt. %, from about 20 wt. % to about 25 wt. %, from about 2 wt. % to about 20 wt. %, from about 5 wt. % to about 20 wt. %, from about 10 wt. % to about 20 wt. %, from about 15 wt. % to about 20 wt. %, from about 2 wt. % to about 15 wt. %, from about 5 wt. % to about 15 wt. %, from about 10 wt. % to about 15 wt. %, from about 2 wt. % to about 10 wt. %, from about 5 wt. % to about 10 wt. %, from about 2 wt. % to about 5 wt. %, or any other suitable values and sub-ranges there-between, based on the total dry weight of the body 12.

In some embodiments, the filler may be perlite, which may be present in an amount ranging from about 5 wt. % to about 60 wt. % based on the total weight of the body 120—including all amounts and sub-ranges there-between. For example, in some embodiments, perlite may be present in an amount ranging from about 5 wt. % to about 60 wt. %, from about 10 wt. % to about 60 wt. %, from about 15 wt. % to about 60 wt. %, from about 20 wt. % to about 60 wt. %, from about 25 wt. % to about 60 wt. %, from about 30 wt. % to about 60 wt. %, from about 35 wt. % to about 60 wt. %, from about 40 wt. % to about 60 wt. %, from about 45 wt. % to about 60 wt. %, from about 50 wt. % to about 60 wt. %, from about 55 wt. %, to about 60 wt. %, from about 5 wt. % to about 55 wt. %, from about 10 wt. % to about 55 wt. %, from about 15 wt. % to about 55 wt. %, from about 20 wt. % to about 55 wt. %, from about 25 wt. % to about 55 wt. %, from about 30 wt. % to about 55 wt. %, from about 35 wt. % to about 55 wt. %, from about 40 wt. % to about 55 wt. %, from about 45 wt. % to about 55 wt. %, from about 50 wt. % to about 55 wt. %, from about 5 wt. % to about 50 wt. %, from about 10 wt. % to about 50 wt. %, from about 15 wt. % to about 50 wt. %, from about 20 wt. % to about 50 wt. %, from about 25 wt. % to about 50 wt. %, from about 30 wt. % to about 50 wt. %, from about 35 wt. % to about 50 wt. %, from about 40 wt. % to about 50 wt. %, from about 45 wt. % to about 50 wt. %, from about 5 wt. % to about 45 wt. %, from about 10 wt. % to about 45 wt. %, from about 15 wt. % to about 45 wt. %, from about 20 wt. % to about 45 wt. %, from about 25 wt. % to about 45 wt. %, from about 30 wt. % to about 45 wt. %, from about 35 wt. % to about 45 wt. %, from about 40 wt. % to about 45 wt. %, from about 5 wt. % to about 40 wt. %, from about 10 wt. % to about 40 wt. %, from about 15 wt. % to about 40 wt. %, from about 20 wt. % to about 40 wt. %, from about 25 wt. % to about 40 wt. %, from about 30 wt. % to about 40 wt. %, from about 35 wt. % to about 40 wt. %, from about 5 wt. % to about 35 wt. %, from about 10 wt. % to about 35 wt. %, from about 15 wt. % to about 35 wt. %, from about 20 wt. % to about 35 wt. %, from about 25 wt. % to about 35 wt. %, from about 30 wt. % to about 35 wt. %, from about 5 wt. % to about 30 wt. %, from about 10 wt. % to about 30 wt. %, from about 15 wt. % to about 30 wt. %, from about 20 wt. % to about 30 wt. %, from about 25 wt. % to about 30 wt. %, from about 5 wt. % to about 25 wt. %, from about 10 wt. % to about 25 wt. %, from about 15 wt. % to about 25 wt. %, from about 20 wt. % to about 25 wt. %, from about 5 wt. % to about 20 wt. %, from about 10 wt. % to about 20 wt. %, from about 15 wt. % to about 20 wt. %, from about 5 wt. % to about 15 wt. %, from about 10 wt. % to about 15 wt. %, from about 5 wt. % to about 10 wt. %, or any other suitable values and sub-ranges there-between, based on the total weight of the body 120.

In some embodiments, the body 120 may include one or more additives. Non-limiting examples of additive include defoamers, wetting agents, biocides, dispersing agents, and the like. The additive may be present in an amount ranging from about 0.01 wt. % to about 30 wt. % based on the total dry weight of the body 120—including all values and sub-ranges there-between.

In some embodiments, the body 120 may further comprise a flocculant. Non-limiting examples of flocculants include ionic flocculants, such as cationic polyacrylamide. The flocculant may be present in an amount ranging from about 0.01 wt. % to about 1.0 wt. % based on the total dry weight of the body 120—including all values and sub-ranges there-between.

In some embodiments, the body 120 may be porous, thereby allowing airflow through the body 120 between the upper surface 122 and the lower surface 121—as discussed further herein. The porosity of the body 120 may allow for airflow through the body 120 under atmospheric conditions such that the building panel 100 may function as an acoustic ceiling panel, which requires properties related to noise reduction and sound attenuation properties—as discussed further herein.

Specifically, in some embodiments, the body 120 of the present invention may have a porosity ranging from about 60% to about 98%—including all values and sub-ranges there between. In some embodiments, the body 120 may have a porosity ranging from about 75% to 95%—including all values and sub-ranges there between. In some embodiments, the body 120 may have a porosity ranging from about 80% to 95%—including all values and sub-ranges there between. In some embodiments, the body 120 may have a porosity ranging from about 85% to 95%—including all values and sub-ranges there between. In some embodiments, the body 120 may have a porosity ranging from about 90% to 95%—including all values and sub-ranges there between.

According to the present invention, porosity refers to the following:

% Porosity=[V_{Total}−(V_{Binder}+V_{Fiber}+V_{Biochar}+V_{Flame Retardant}+V_{Filler/Additive})]/V_{Total}

Where V_{Total} refers to the total volume of the body 120 defined by the upper surface 122, the lower surface 121, and the body side surfaces 123. V_{Binder} refers to the total volume occupied by the binder in the body 120. V_{Fiber} refers to the total volume occupied by the fibers 130 in the body 120. V_{Biochar} refers to the total volume occupied by the biochar in the body 120. V_{Flame Retardant} refers to the total volume occupied by the flame retardant in the body 120. V_{Filler/Additive} refers to the total volume occupied by the filler and additive in the body 120. Thus, the % porosity represents the amount of free volume within the body 120.

In some embodiments, the building panel 100 including the porous body 120 may exhibit sufficient airflow for the building panel 100 to have the ability to reduce the amount of reflected sound in a room. The reduction in amount of reflected sound in a room is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 100 of the present invention may exhibit an NRC of at least about 0.5. In some embodiments, the building panel 100 of the present invention may have an NRC ranging from about 0.60 to about 0.99—including all value and sub-ranges there-between.

The body 120 may also exhibit an airflow resistance as measured between the upper surface 122 and the lower surface 121 that ranges from about 200 MKS Rayls to about 40,000 MKS Rayls—including all airflow resistances and sub-ranges there-between—MKS Rayls being measured in units of Pa*s/m.

In some embodiments, the body 120 in the dry-state may have a bulk density ranging from about 0.04 g/cm³ to about 0.6 g/cm³, such as 0.048 g/cm³ to about 0.577 g/cm³—including all integers and sub-ranges there between. For example, in some embodiments, the body 120 in the dry-state may have a bulk density ranging from about 0.04 g/cm³ to about 0.6 g/cm³, from about 0.045 g/cm³ to about 0.6 g/cm³, from about 0.05 g/cm³ to about 0.6 g/cm³, from about 0.075 g/cm³ to about 0.6 g/cm³, from about 0.1 g/cm³ to about 0.6 g/cm³, from about 0.15 g/cm³ to about 0.6 g/cm³, from about 0.2 g/cm³ to about 0.6 g/cm³, from about 0.25 g/cm³ to about 0.6 g/cm³, from about 0.3 g/cm³ to about 0.6 g/cm³, from about 0.35 g/cm³ to about 0.6 g/cm³, from about 0.4 g/cm³ to about 0.6 g/cm³, from about 0.45 g/cm³ to about 0.6 g/cm³, from about 0.5 g/cm³ to about 0.6 g/cm³, from about 0.55 g/cm³ to about 0.6 g/cm³, from about 0.04 g/cm³ to about 0.55 g/cm³, from about 0.045 g/cm³ to about 0.55 g/cm³, from about 0.05 g/cm³ to about 0.55 g/cm³, from about 0.075 g/cm³ to about 0.55 g/cm³, from about 0.1 g/cm³ to about 0.55 g/cm³, from about 0.15 g/cm³ to about 0.55 g/cm³, from about 0.2 g/cm³ to about 0.55 g/cm³, from about 0.25 g/cm³ to about 0.55 g/cm³, from about 0.3 g/cm³ to about 0.55 g/cm³, from about 0.35 g/cm³ to about 0.55 g/cm³, from about 0.4 g/cm³ to about 0.55 g/cm³, from about 0.45 g/cm³ to about 0.55 g/cm³, from about 0.5 g/cm³ to about 0.55 g/cm³, from about 0.04 g/cm³ to about 0.5 g/cm³, from about 0.045 g/cm³ to about 0.5 g/cm³, from about 0.05 g/cm³ to about 0.5 g/cm³, from about 0.075 g/cm³ to about 0.5 g/cm³, from about 0.1 g/cm³ to about 0.5 g/cm³, from about 0.15 g/cm³ to about 0.5 g/cm³, from about 0.2 g/cm³ to about 0.5 g/cm³, from about 0.25 g/cm³ to about 0.5 g/cm³, from about 0.3 g/cm³ to about 0.5 g/cm³, from about 0.35 g/cm³ to about 0.5 g/cm³, from about 0.4 g/cm³ to about 0.5 g/cm³, from about 0.45 g/cm³ to about 0.5 g/cm³, from about 0.04 g/cm³ to about 0.45 g/cm³, from about 0.045 g/cm³ to about 0.45 g/cm3, from about 0.05 g/cm³ to about 0.45 g/cm³, from about 0.075 g/cm³ to about 0.45 g/cm³, from about 0.1 g/cm³ to about 0.45 g/cm³, from about 0.15 g/cm³ to about 0.45 g/cm³, from about 0.2 g/cm³ to about 0.45 g/cm³, from about 0.25 g/cm³ to about 0.45 g/cm³, from about 0.3 g/cm³ to about 0.45 g/cm³, from about 0.35 g/cm³ to about 0.45 g/cm³, from about 0.4 g/cm³ to about 0.45 g/cm³, from about 0.04 g/cm³ to about 0.4 g/cm³, from about 0.045 g/cm³ to about 0.4 g/cm³, from about 0.05 g/cm³ to about 0.4 g/cm³, from about 0.075 g/cm³ to about 0.4 g/cm³, from about 0.1 g/cm³ to about 0.4 g/cm³, from about 0.15 g/cm³ to about 0.4 g/cm³, from about 0.2 g/cm³ to about 0.4 g/cm³, from about 0.25 g/cm³ to about 0.4 g/cm³, from about 0.3 g/cm³ to about 0.4 g/cm³, from about 0.35 g/cm³ to about 0.4 g/cm³, from about 0.04 g/cm³ to about 0.35 g/cm³, from about 0.045 g/cm³ to about 0.35 g/cm³, from about 0.05 g/cm³ to about 0.35 g/cm³, from about 0.075 g/cm³ to about 0.35 g/cm³, from about 0.1 g/cm³ to about 0.35 g/cm³, from about 0.15 g/cm³ to about 0.35 g/cm³, from about 0.2 g/cm³ to about 0.35 g/cm³, from about 0.25 g/cm³ to about 0.35 g/cm³, from about 0.3 g/cm³ to about 0.35 g/cm³, from about 0.04 g/cm³ to about 0.3 g/cm³, from about 0.045 g/cm³ to about 0.3 g/cm³, from about 0.05 g/cm³ to about 0.3 g/cm³, from about 0.075 g/cm³ to about 0.3 g/cm³, from about 0.1 g/cm³ to about 0.3 g/cm³, from about 0.15 g/cm³ to about 0.3 g/cm³, from about 0.2 g/cm³ to about 0.3 g/cm³, from about 0.25 g/cm³ to about 0.3 g/cm³, from about 0.04 g/cm³ to about 0.25 g/cm³, from about 0.045 g/cm³ to about 0.25 g/cm³, from about 0.05 g/cm³ to about 0.25 g/cm³, from about 0.075 g/cm³ to about 0.25 g/cm³, from about 0.1 g/cm³ to about 0.25 g/cm³, from about 0.15 g/cm³ to about 0.25 g/cm³, from about 0.2 g/cm³ to about 0.25 g/cm³, from about 0.04 g/cm³ to about 0.2 g/cm³, from about 0.045 g/cm³ to about 0.2 g/cm³, from about 0.05 g/cm³ to about 0.2 g/cm³, from about 0.075 g/cm³ to about 0.2 g/cm³, from about 0.1 g/cm³ to about 0.2 g/cm³, from about 0.15 g/cm³ to about 0.2 g/cm³, from about 0.04 g/cm³ to about 0.15 g/cm³, from about 0.045 g/cm³ to about 0.15 g/cm³, from about 0.05 g/cm³ to about 0.15 g/cm³, from about 0.075 g/cm³ to about 0.15 g/cm³, from about 0.1 g/cm³ to about 0.15 g/cm³, from about 0.04 g/cm³ to about 0.1 g/cm³, from about 0.045 g/cm³ to about 0.1 g/cm³, from about 0.05 g/cm³ to about 0.1 g/cm³, from about 0.075 g/cm³ to about 0.1 g/cm³, from about 0.04 g/cm³ to about 0.075 g/cm³, from about 0.045 g/cm³ to about 0.075 g/cm³, from about 0.05 g/cm³ to about 0.075 g/cm³, from about 0.04 g/cm³ to about 0.05 g/cm³, from about 0.045 g/cm³ to about 0.05 g/cm³, or any other suitable values and sub-ranges there-between.

The term “bulk density” refers to the density as measured relative to the total volume V_{Total} of the body 120. Therefore, bulk density is a density measurement of that includes the total volume V_{Total}, which includes both the volume occupied by the components that make up the skeleton of the body 120 (i.e., (V_{Binder}+V_{Fiber}+V_{Biochar}+V_{Flame Retardant}+V_{Filler/Additive}) as well as the voids within the body 120 due to the porous nature of the body 120.

The body 120 in the dry-state may have a skeletal density ranging from about 0.5 g/cm³ to about 2.5 g/cm³, such as from about 1 g/cm³ to about 2.2 g/cm³, including all integers and sub-ranges there between. For example, in some embodiments, the body 120 in the dry-state may have a skeletal density ranging from about 0.5 g/cm³ to about 2.5 g/cm³, from about 1 g/cm³ to about 2.5 g/cm³, from about 1.25 g/cm³ to about 2.5 g/cm³, from about 1.5 g/cm³ to about 2.5 g/cm³, from about 1.75 g/cm³ to about 2.5 g/cm³, from about 2 g/cm³ to about 2.5 g/cm³, from about 0.5 g/cm³ to about 2.25 g/cm³, from about 1 g/cm³ to about 2.25 g/cm³, from about 1.25 g/cm³ to about 2.25 g/cm³, from about 1.5 g/cm³ to about 2.25 g/cm³, from about 1.75 g/cm³ to about 2.25 g/cm³, from about 2 g/cm³ to about 2.25 g/cm³, from about 0.5 g/cm³ to about 2 g/cm³, from about 1 g/cm³ to about 2 g/cm³, from about 1.25 g/cm³ to about 2 g/cm³, from about 1.5 g/cm³ to about 2 g/cm³, from about 1.75 g/cm³ to about 2 g/cm³, from about 0.5 g/cm³ to about 1.75 g/cm³, from about 1 g/cm³ to about 1.75 g/cm³, from about 1.25 g/cm³ to about 1.75 g/cm³, from about 1.5 g/cm³ to about 1.75 g/cm³, from about 0.5 g/cm³ to about 1.5 g/cm³, from about 1 g/cm³ to about 1.5 g/cm³, from about 1.25 g/cm³ to about 1.5 g/cm³, from about 0.5 g/cm³ to about 1.25 g/cm³, from about 1 g/cm³ to about 1.25 g/cm³, or any other suitable values and sub-ranges there-between.

The term “skeletal density” refers to the density as measured relative to only the volume occupied by the components that make up the skeleton of the body 120 (i.e., (V_{Binder}+V_{Fiber}+V_{Biochar}+V_{Flame Retardant}+V_{Filler/Additive}) without accounting for the volume occupied by the voids within the body 120 due to the porous nature of the body 120.

Although not pictured, the building panel 100 of the present invention may further comprise a scrim attached to at least one of the lower surface 121 or the upper surface 122 of the body 120. The scrim may be a non-woven scrim formed of glass fibers. In such embodiments, the first major surface 111 of the building panel 100 may comprise the scrim.

In some embodiments, the body 120 may be formed according to a standard wet-laid process that uses an aqueous medium or liquid carrier (e.g., water) to transport and form the body components into the desired structure. The basic process involves first blending the various body ingredients (e.g., fibers, binder, biochar, flame retardant, filler, additive, etc.) into an aqueous slurry—(i.e., the wet-state), transporting the slurry to a forming station, and distributing the slurry over a moving, porous wire web into a uniform mat having the desired size and thickness. The liquid carrier is removed, and the mat is dried (i.e., the dry-state). The dried mat may be finished into the body by slitting, punching, coating and/or laminating a surface finish. The body 120 in the wet-state may be heated at an elevated temperature ranging from about 60° C. to about 200° C.—including all values and sub-ranges there-between—to dry the body 120 from the wet-state to the dry-state.

The following examples are prepared in accordance with certain embodiments of the present invention. The present invention is not limited to the examples described herein.

### Examples

Experiments were performed to evaluate the effect of select flame retardant on stopping smoldering as observed in certain biochar-containing building panels. Three building panels (Ex. 1, Ex. 2, and Ex. 3) according to embodiments of the present invention were prepared. The building panels (Ex. 1, Ex. 2, and Ex. 3) each contained biochar and a flame retardant at a different weight ratio. A control panel (Comp. Ex. 1) that contained only biochar, but no flame retardant, was also prepared. Each of the panels included a body formed of a formulation set forth below in Table 1—each amount listed is in weight percentage (wt. %).

TABLE 1

| | Comp. | | | |
|---|---|---|---|---|
| | Ex. 1 | Ex. 1 | Ex. 2 | Ex. 3 |
| Inorganic Fiber (Mineral Wool) | 62 | 42 | 52 | 57 |
| Organic Fiber (Newsprint) | 5 | 5 | 5 | 5 |
| Binder (Starch) | 8 | 8 | 8 | 8 |
| Filler (Perlite) | 5 | 5 | 5 | 5 |
| Biochar | 20 | 20 | 20 | 20 |
| Flame Retardant (Colemanite) | — | 20 | 10 | 5 |
| Total | 100 | 100 | 100 | 100 |
| Biochar:Flame Retardant | — | 1:1 | 2:1 | 4:1 |

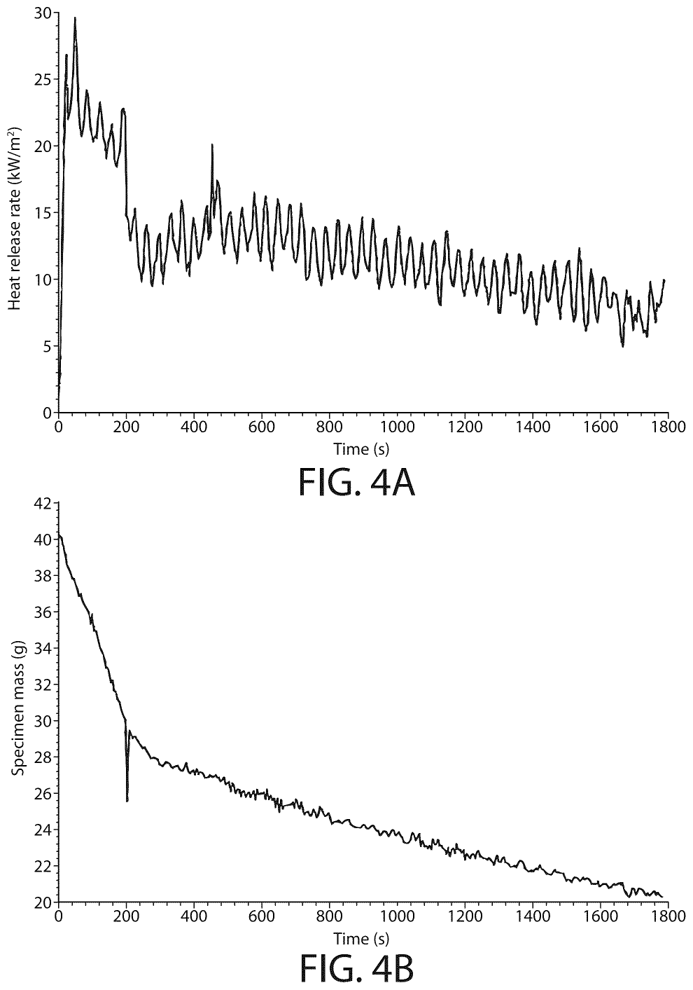

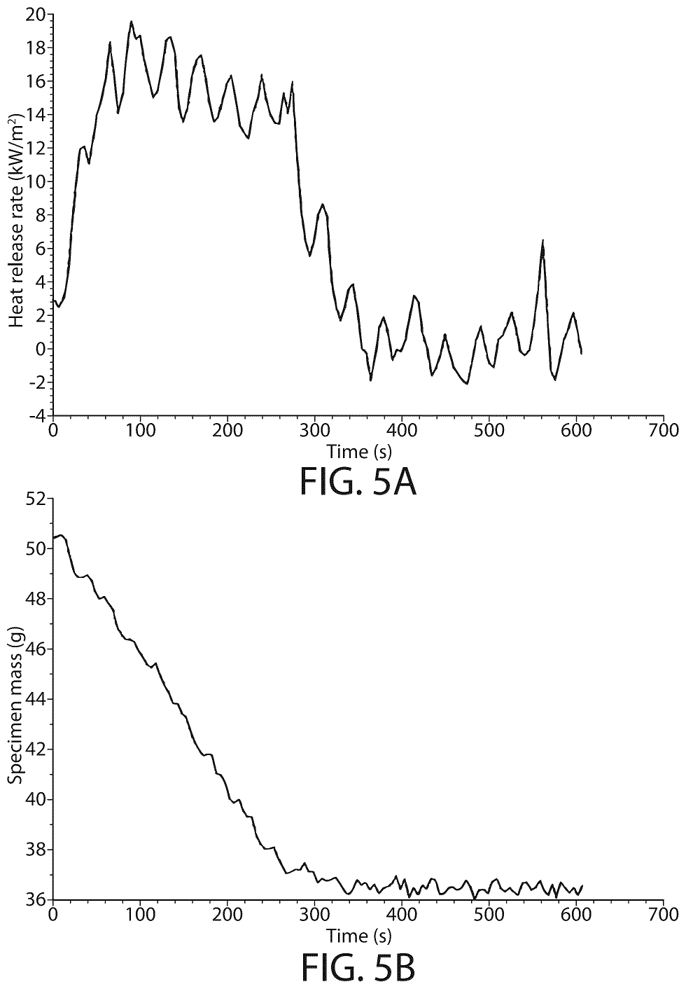

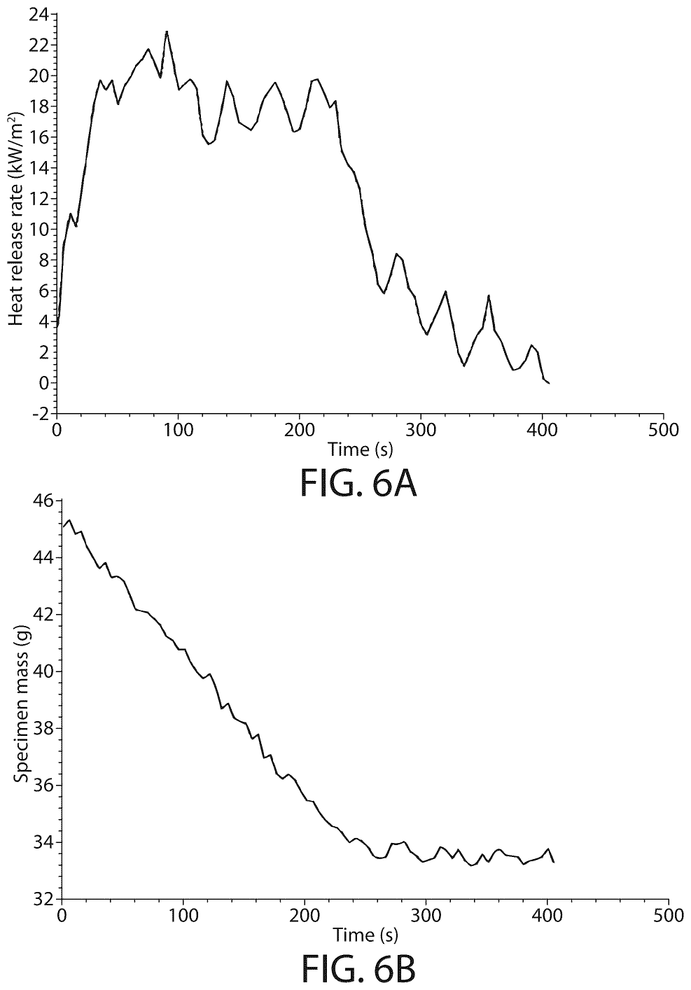

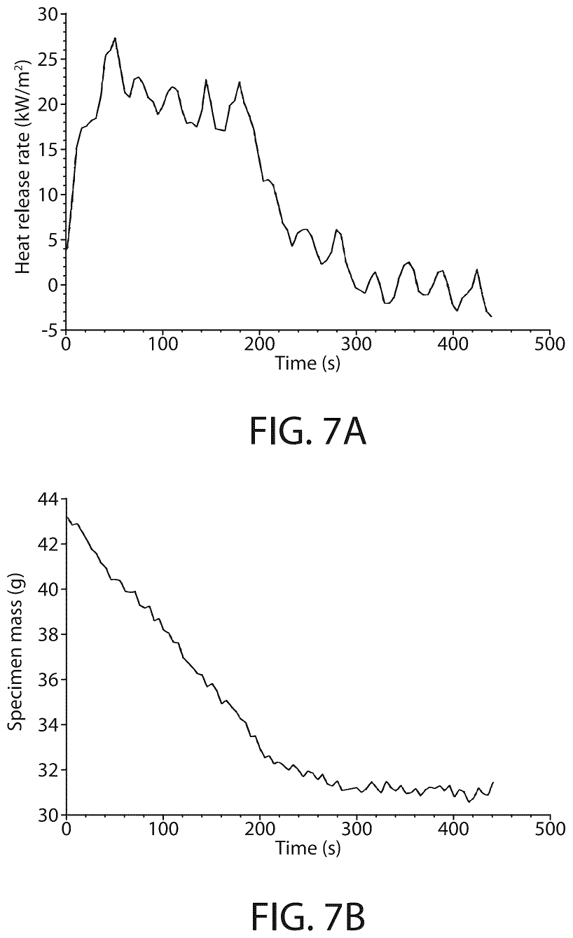

The panels were tested in a cone calorimeter using modified cone method ASTM E1354. Specifically, heat was applied for only the first 180 seconds of the test. Heat release and mass loss of each panel were measured. FIGS. 4A and 4B show the heat release rate and the panel mass of the control panel (Comp. Ex. 1). FIGS. 5A and 5B show the heat release rate and the panel mass of the first exemplary building panel (Ex. 1) having a biochar to flame retardant weight ratio of 1:1. FIGS. 6A and 6B show the heat release rate and the panel mass of the second exemplary building panel (Ex. 2) having a biochar to flame retardant weight ratio of 2:1. FIGS. 7A and 7B show the heat release rate and the panel mass of the third exemplary building panel (Ex. 3) having a biochar to flame retardant weight ratio of 4:1.

The inventors discovered that the inclusion of the flame retardant at the various levels all successfully stopped smoldering that was observed in the control panel. As shown in FIGS. 4A and 4B, when heat supply was cut off at 180 seconds, the control panel (Comp. Ex. 1) continued to release heat, and the panel mass continued to decrease, both of which are indicative of smoldering. The addition of colemanite as the flame retardant in the exemplary panels (Ex. 1, Ex. 2, and Ex. 3) at the various levels all effectively stopped heat release from the panel soon after the heat supply was cut off, as demonstrated in FIGS. 5A, 6A, and 7A, and the panel masses were maintained, as shown in FIGS. 5B, 6B, and 7B. In other words, the exemplary building panels (Ex. 1, Ex. 2, and Ex. 3) did not continue to burn without a flame (smolder).

As demonstrated, the embodiments described herein provide acoustic building panels that include a body formed, in part, of biochar to reduce carbon dioxide emission while eliminating any potential smoldering issues that may be posed by the inclusion of biochar in certain biochar-containing building panels.

### EXEMPLARY CLAIM SET

Exemplary Claim 1. An acoustic building panel, comprising: a body comprising: inorganic fiber in an amount ranging from about 5 wt. % to about 75 wt. % based on the total weight of the body; biochar in an amount ranging from about 5 wt. % to about 50 wt. % based on the total weight of the body; and a flame retardant in an amount ranging from about 1 wt. % to about 30 wt. % based on the total weight of the body; wherein the biochar and the flame retardant are present in a weight ratio ranging from about 1:1 to about 6:1.

Exemplary Claim 2. The acoustic building panel according to Exemplary Claim 1, wherein the inorganic fiber comprises mineral wool.

Exemplary Claim 3. The acoustic building panel according to any one of Exemplary Claims 1 to 2, wherein the flame retardant comprises an active filler flame retardant

Exemplary Claim 4. The acoustic building panel according to any one of Exemplary Claims 1 to 3, wherein the flame retardant decomposes endothermically.

Exemplary Claim 5. The acoustic building panel according to any one of Exemplary Claims 1 to 4, wherein the flame retardant decomposes endothermically at an elevated temperature ranging from about 200° C. to about 325° C.

Exemplary Claim 6. The acoustic building panel according to any one of Exemplary Claims 1 to 5, wherein the flame retardant emits water (H₂O) upon decomposition.

Exemplary Claim 7. The acoustic building panel according to any one of Exemplary Claims 1 to 6, wherein the flame retardant comprises at least one of colemanite, aluminum hydroxide, magnesium hydroxide, boehmite, hydrous or calcined clay, calcium carbonate, talc, or feldspar.

Exemplary Claim 8. The acoustic building panel according to any one of Exemplary Claims 1 to 7, wherein the flame retardant has an average particle size ranging from about 1 μm to about 100 μm.

Exemplary Claim 9. The acoustic building panel according to any one of Exemplary Claims 1 to 8, wherein the biochar has an average particle size ranging from about 0.1 mm to about 5 mm.

Exemplary Claim 10. The acoustic building panel according to any one of Exemplary Claims 1 to 9, wherein the body further comprises organic fiber in an amount ranging from about 3 wt. % to about 25 wt. % based on the total weight of the body.

Exemplary Claim 11. The acoustic building panel according to any one of Exemplary Claims 1 to 10, wherein the body further comprises a binder in an amount ranging from about 3 wt. % to about 15 wt. %, based on the total weight of the body.

Exemplary Claim 12. The acoustic building panel according to Exemplary Claim 11, wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

Exemplary Claim 13. The acoustic building panel according to any one of Exemplary Claims 1 to 12, wherein the body further comprises a filler in an amount ranging from about 2 wt. % to about 60 wt. % based on the total weight of the body.

Exemplary Claim 14. The acoustic building panel according to Exemplary Claim 13, wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

Exemplary Claim 15. The acoustic building panel according to any one of Exemplary Claims 1 to 14, wherein the body has a porosity ranging from about 80% to about 95%.

Exemplary claim 16. The acoustic building panel according to any one of Exemplary Claims 1 to 15, wherein the body has a bulk density ranging from about 0.04 g/cm³ to about 0.6 g/cm³.

Exemplary Claim 17. The acoustic building panel according to any one of Exemplary Claims 1 to 16, wherein the body has a skeletal density ranging from about 0.5 g/cm³ to about 2.5 g/cm³.

Exemplary Claim 18. The acoustic building panel according to any one of Exemplary Claims 1 to 17, wherein the body has a first major surface opposite a second major surface and a side surface extending there between, and wherein the body exhibits an airflow resistance ranging from about 200 MKS Rayls to about 40,000 MKS Rayls as measured between the first major surface and the second major surface.

Exemplary Claim 19. An acoustic building panel, comprising: a body comprising: inorganic fiber in an amount ranging from about 5 wt. % to about 75 wt. % based on the total weight of the body; biochar in an amount ranging from about 5 wt. % to about 50 wt. % based on the total weight of the body; and a flame retardant in an amount ranging from about 1 wt. % to about 30 wt. % based on the total weight of the body; wherein the flame retardant comprises colemanite.

Exemplary Claim 20. The acoustic building panel according to Exemplary Claim 19, wherein the inorganic fiber comprises mineral wool.

Exemplary Claim 21. The acoustic building panel according to any one of Exemplary Claims 19 to 20, wherein the flame retardant has an average particle size ranging from about 1 μm to about 100 μm.

Exemplary Claim 22. The acoustic building panel according to any one of Exemplary Claims 19 to 21, wherein the flame retardant decomposes endothermically at an elevated temperature ranging from about 200° C. to about 325° C.

Exemplary Claim 23. The acoustic building panel according to any one of Exemplary Claims 19 to 22, wherein the flame retardant emits water (H₂O) upon decomposition.

Exemplary Claim 24. The acoustic building panel according to any one of Exemplary Claims 19 to 23, wherein the biochar has an average particle size ranging from about 0.1 mm to about 5 mm.

Exemplary Claim 25. The acoustic building panel according to any one of Exemplary Claims 19 to 24, wherein the body further comprises organic fiber in an amount ranging from about 3 wt. % to about 25 wt. % based on the total weight of the body.

Exemplary Claim 26. The acoustic building panel according to any one of Exemplary Claims 19 to 25, wherein the body further comprises a binder in an amount ranging from about 3 wt. % to about 15 wt. % based on the total weight of the body.

Exemplary Claim 27. The acoustic building panel according to Exemplary Claim 26, wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

Exemplary Claim 28. The acoustic building panel according to any one of Exemplary Claims 19 to 27, wherein the body further comprises a filler in an amount ranging from about 2 wt. % to about 60 wt. % based on the total weight of the body.

Exemplary Claim 29. The acoustic building panel according to any one of Exemplary Claims 19 to 28, wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

Exemplary Claim 30. The acoustic building panel according to any one of Exemplary Claims 19 to 29, wherein the body has a porosity ranging from about 80% to about 95%.

Exemplary Claim 31. The acoustic building panel according to any one of Exemplary Claims 19 to 30, wherein the body has a bulk density ranging from about 0.04 g/cm³ to about 0.6 g/cm³.

Exemplary Claim 32. The acoustic building panel according to any one of Exemplary Claims 19 to 31, wherein the body has a skeletal density ranging from about 0.5 g/cm³ to about 2.5 g/cm³.

Exemplary Claim 33. The acoustic building panel according to any one of Exemplary Claims 19 to 31, wherein the body has a first major surface opposite a second major surface and a side surface extending there between, and wherein the body exhibits an airflow resistance ranging from about 200 MKS Rayls to about 40,000 MKS Rayls as measured between the first major surface and the second major surface.

Exemplary Claim 34. A ceiling system comprising: a support structure; and at least one of the acoustic building panel according to anyone of Exemplary Claims 1 to 33 mounted to the support structure.

Exemplary Claim 35. A method of manufacturing an acoustic building panel comprising: mixing inorganic fiber, binder, biochar, a flame retardant, and a liquid carrier to form a blend; and shaping and drying the blend into a body having a first major surface opposite a second major surface and side surfaces extending between the first and second major surface, wherein the body is substantially free of the liquid carrier; wherein the biochar and the flame retardant are present in a weight ratio ranging from about 1:1 to about 6:1.

Exemplary Claim 36. The method according to Exemplary Claim 35, wherein the blend further comprises an organic fibrous material, and wherein the organic fibrous material is present in an amount ranging from about 3 wt. % to about 25 wt. % based on the total weight of the body.

Exemplary Claim 37. The method according to any one of Exemplary Claims 35 to 36, wherein the inorganic fiber comprises mineral wool, and wherein the inorganic fiber is present in an amount ranging from about 5 wt. % to about 75 wt. % based on the total weight of the body.

Exemplary Claim 38. The method according to any one of Exemplary Claims 35 to 37, wherein the flame retardant comprises an active filler flame retardant, and wherein the flame retardant is present in an amount ranging from about 1 wt. % to about 30 wt. % based on the total weight of the body.

Exemplary Claim 39. The method according to any one of Exemplary Claims 35 to 38, wherein the flame retardant decomposes endothermically.

Exemplary Claim 40. The method according to any one of Exemplary Claims 35 to 39, wherein the flame retardant decomposes endothermically at an elevated temperature ranging from about 200° C. to about 325° C.

Exemplary Claim 41. The method according to any one of Exemplary Claims 35 to 40, wherein the flame retardant emits water (H₂O) upon decomposition.

Exemplary Claim 42. The method according to any one of Exemplary Claims 35 to 41, wherein the flame retardant comprises at least one of colemanite, aluminum hydroxide, magnesium hydroxide, boehmite, hydrous or calcined clay, calcium carbonate, talc, or feldspar.

Exemplary Claim 43. The method according to any one of Exemplary Claims 35 to 42, wherein the flame retardant has an average particle size ranging from about 1 μm to about 100 μm.

Exemplary Claim 44. The method according to any one of Exemplary Claims 35 to 43, wherein the biochar has an average particle size ranging from about 0.1 mm to about 5 mm.

Exemplary Claim 45. The method according to any one of Exemplary Claims 35 to 44, wherein the binder is present in an amount ranging from about 3 wt. % to about 15 wt. % based on the total weight of the body.

Exemplary Claim 46. The method according to Exemplary Claim 45, wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

Exemplary Claim 47. The method according to any one of Exemplary Claims 35 to 46, wherein the blend further comprises a filler, and wherein the filler is present in an amount ranging from about 2 wt. % to about 60 wt. % based on the total weight of the body.

Exemplary Claim 48. The method according to Exemplary Claim 47, wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

Exemplary Claim 49. The method according to any one of Exemplary Claims 35 to 48, wherein the body has a porosity ranging from about 80% to about 95%.

Exemplary Claim 50. The method according to any one of Exemplary Claims 35 to 49, wherein the body has a bulk density ranging from about 0.04 g/cm³ to about 0.6 g/cm³.

Exemplary Claim 51. The method according to any one of Exemplary Claims 35 to 50, wherein the body has a skeletal density ranging from about 0.5 g/cm³ to about 2.5 g/cm³.

Exemplary Claim 52. The method according to any one of Exemplary Claims 35 to 51, wherein the body exhibits an airflow resistance ranging from about 200 MKS Rayls to about 40,000 MKS Rayls as measured between the first major surface and the second major surface.

Exemplary Claim 53. The method according to any one of Exemplary Claims 35 to 52, wherein the liquid carrier comprises water.

Exemplary Claim 54. A method of manufacturing an acoustic building panel comprising: mixing inorganic fiber, binder, biochar, a flame retardant, and a liquid carrier to form a blend; and shaping and drying the blend into a body having a first major surface opposite a second major surface and side surfaces extending between the first and second major surface, wherein the body is substantially free of the liquid carrier; wherein the flame retardant comprises colemanite.

Exemplary Claim 55. The method according to Exemplary Claim 54, wherein the blend further comprises an organic fibrous material, and wherein the organic fibrous material is present in an amount ranging from about 3 wt. % to about 25 wt. % based on the total weight of the body.

Exemplary Claim 56. The method according to any one of Exemplary Claims 54 to 55, wherein the inorganic fiber comprises mineral wool, and wherein the inorganic fiber is present in an amount ranging from about 5 wt. % to about 75 wt. % based on the total weight of the body.

Exemplary Claim 57. The method according to any one of Exemplary Claims 54 to 56, wherein the flame retardant is present in an amount ranging from about 1 wt. % to about 30 wt. % based on the total weight of the body.

Exemplary Claim 58. The method according to any one of Exemplary Claims 54 to 57, wherein the flame retardant decomposes endothermically at an elevated temperature ranging from about 200° C. to about 325° C.

Exemplary Claim 59. The method according to any one of Exemplary Claims 54 to 58, wherein the flame retardant emits water (H₂O) upon decomposition.

Exemplary Claim 60. The method according to any one of Exemplary Claims 54 to 59, wherein the flame retardant has an average particle size ranging from about 1 μm to about 100 μm.

Exemplary Claim 61. The method according to any one of Exemplary Claims 54 to 60, wherein the biochar has an average particle size ranging from about 0.1 mm to about 5 mm.

Exemplary Claim 62. The method according to any one of Exemplary Claims 54 to 61, wherein the binder is present in an amount ranging from about 3 wt. % to about 15 wt. % based on the total weight of the body.

Exemplary Claim 63. The method according to Exemplary Claim 62, wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

Exemplary Claim 64. The method according to any one of Exemplary Claims 54 to 63, wherein the blend further comprises a filler, and wherein the filler is present in an amount ranging from about 2 wt. % to about 60 wt. % based on the total weight of the body.

Exemplary Claim 65. The method according to Exemplary Claim 64, wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

Exemplary Claim 66. The method according to any one of Exemplary Claims 54 to 65, wherein the body has a porosity ranging from about 80% to about 95%.

Exemplary Claim 67. The method according to any one of Exemplary Claims 54 to 66, wherein the body has a bulk density ranging from about 0.04 g/cm³ to about 0.6 g/cm³.

Exemplary Claim 68. The method according to any one of Exemplary Claims 54 to 67, wherein the body has a skeletal density ranging from about 0.5 g/cm³ to about 2.5 g/cm³.

Exemplary Claim 69. The method according to any one of Exemplary Claims 54 to 68, wherein the body exhibits an airflow resistance ranging from about 200 MKS Rayls to about 40,000 MKS Rayls as measured between the first major surface and the second major surface.

Exemplary Claim 70. The method according to any one of Exemplary Claims 54 to 69, wherein the liquid carrier comprises water.

1. An acoustic building panel, comprising:
a body comprising:
inorganic fiber in an amount ranging from about 5 wt. % to about 75 wt. % based on the total weight of the body;
biochar in an amount ranging from about 5 wt. % to about 50 wt. % based on the total weight of the body; and
a flame retardant in an amount ranging from about 1 wt. % to about 30 wt. % based on the total weight of the body;
wherein the biochar and the flame retardant are present in a weight ratio ranging from about 1:1 to about 6:1.

2. An acoustic building panel, comprising:
a body comprising:
inorganic fiber in an amount ranging from about 5 wt. % to about 75 wt. % based on the total weight of the body;
biochar in an amount ranging from about 5 wt. % to about 50 wt. % based on the total weight of the body; and
a flame retardant in an amount ranging from about 1 wt. % to about 30 wt. % based on the total weight of the body;
wherein the flame retardant comprises colemanite.

3. The acoustic building panel according to claim 0, wherein the inorganic fiber comprises mineral wool.

4. The acoustic building panel according to claim 0, wherein the flame retardant comprises an active filler flame retardant.

5. The acoustic building panel according to claim 0, wherein the flame retardant decomposes endothermically.

6. The acoustic building panel according to claim 0, wherein the flame retardant decomposes endothermically at an elevated temperature ranging from about 200° C. to about 325° C.

7. The acoustic building panel according to claim 0, wherein the flame retardant emits water (H₂O) upon decomposition.

8. The acoustic building panel according to claim 0, wherein the flame retardant comprises at least one of colemanite, aluminum hydroxide, magnesium hydroxide, boehmite, hydrous or calcined clay, calcium carbonate, talc, or feldspar.

9. The acoustic building panel according to claim 0, wherein the flame retardant has an average particle size ranging from about 1 μm to about 100 μm.

10. The acoustic building panel according to claim 0, wherein the biochar has an average particle size ranging from about 0.1 mm to about 5 mm.

11. The acoustic building panel according to claim 0, wherein the body further comprises organic fiber in an amount ranging from about 3 wt. % to about 25 wt. % based on the total weight of the body.

12. The acoustic building panel according to claim 0, wherein the body further comprises a binder in an amount ranging from about 3 wt. % to about 15 wt. %, based on the total weight of the body.

13. The acoustic building panel according to claim Error! Reference source not found., wherein the binder comprises at least one of a starch-based polymer, polyvinyl alcohol (PVOH), a latex, a polysaccharide polymer, a cellulosic polymer, a protein solution polymer, an acrylic polymer, polymaleic anhydride, or an epoxy resin.

14. The acoustic building panel according to claim 0, wherein the body further comprises a filler in an amount ranging from about 2 wt. % to about 60 wt. % based on the total weight of the body.

15. The acoustic building panel according to claim Error! Reference source not found., wherein the filler comprises at least one of perlite, calcium carbonate, limestone, titanium dioxide, sand, barium sulfate, clay, mica, dolomite, silica, talc, wollastonite, calcite, aluminum trihydrate, pigments, zinc oxide, or zinc sulfate.

16. The acoustic building panel according to claim 0, wherein the body has a porosity ranging from about 80% to about 95%.

17. The acoustic building panel according to claim 0, wherein the body has a bulk density ranging from about 0.04 g/cm³ to about 0.6 g/cm³.

18. The acoustic building panel according to claim 0, wherein the body has a skeletal density ranging from about 0.5 g/cm³ to about 2.5 g/cm³.

19. The acoustic building panel according to claim 0, wherein the body has a first major surface opposite a second major surface and a side surface extending there between, and wherein the body exhibits an airflow resistance ranging from about 200 MKS Rayls to about 40,000 MKS Rayls as measured between the first major surface and the second major surface.

20. A method of manufacturing an acoustic building panel comprising:
mixing inorganic fiber, binder, biochar, a flame retardant, and a liquid carrier to form a blend; and
shaping and drying the blend into a body having a first major surface opposite a second major surface and side surfaces extending between the first and second major surface, wherein the body is substantially free of the liquid carrier;
wherein the biochar and the flame retardant are present in a weight ratio ranging from about 1:1 to about 6:1.

21-23. (canceled)
